(19) United States
(12) Patent Application Publication
(10) Pub. No.: US 2012/0206389 A1
(43) Pub. Date: Aug. 16, 2012

(54) TOUCH SENSING APPARATUS

(76) Inventors: Chien-Yu Chan, Hsinchu City (TW); Chien-Kuo Wang, Zhubei City (TW); Sien-Chun Liu, Kaohsiung City (TW); Hung Li, Taipei City (TW); Ko-Yang Tso, Taipei City (TW)

(21) Appl. No.: 13/370,203

(22) Filed: Feb. 9, 2012

(30) Foreign Application Priority Data
Feb. 10, 2011 (TW) 100104389

(51) Int. Cl. G06F 3/041

(52) U.S. Cl. 345/173

(57) ABSTRACT

A touch sensing apparatus includes a plurality of pins, a logic control module, and at least one amplifier module. The logic control module generates a plurality of control signals having different control timings, wherein the control signals include an amplifying control signal and a compensating control signal. Each amplifying module includes an amplifying unit and an automatic compensating unit. The amplifying unit includes a positive input end and a negative input end, wherein the amplifying unit determines, according to the amplifying control signal, a difference between a first sensing voltage and a second sensing voltage respectively received by the positive input end and the negative input end and amplifies the difference to output an analog data. The automatic compensating unit records, according to the compensating control signal, a digital compensation value corresponding to one of the pins and outputs the digital compensation value according to the compensating control signal.

### CROSS-REFERENCE TO RELATED APPLICATIONS

This application claims the benefit of priority from Taiwanese Patent Application No. 100104389, filed on Feb. 10, 2011, which application is incorporated herein by reference.

### BACKGROUND OF THE INVENTION

1. Field of the Invention

The present invention relates generally to a liquid crystal display; particularly, the present invention relates to a mutual capacitance touch sensing apparatus capable of decreasing cost and increasing the touch performance.

2. Description of the Prior Art

As technology rapidly advances, conventional displays are progressively replaced by thin film transistor liquid crystal displays (TFT LCDs). TFT LCDs are widely used in TVs, flat displays, cell phones, tablet PCs, projectors, and other relevant electronic devices. For TFT LCDs having touch function, touch sensors play an important role among all other modules, and performance of the touch sensor affects the overall performance of LCD.

Generally, the conventional LCD having mutual capacitance touch sensing function includes a display panel, a conductive thin film sensor (e.g. ITO sensor), and a touch control chip, wherein the conductive thin film sensor includes a plurality of sensing lines and a plurality of driving lines, and the touch control chip includes a plurality of pins. The sensing lines are coupled with the pins respectively. When the driving line transmits a driving pulse to couple a small voltage at the sensing line, the touch control chip will sense the coupled voltage and determine according to the magnitude of the coupled voltage whether the conductive thin film sensor is touched.

Particularly, the efficiency of the touch sensing apparatus depends on the production yield of the conductive thin film sensor. However, the production cost must increase in order to increase the production yield of the conductive thin film sensor. Moreover, the most expensive component of the touch sensing apparatus is the conductive thin film sensor. In practical applications, the coupled voltage is very small and sensitive, so that the coupled voltage exceeds the determination range owing to the conductive thin film sensor with poor performance. In addition, the touch sensing apparatus determines a coupled voltage having any error, and the error influences the performance of the touch sensor. Even though the coupled voltage having any error does not exceed the acceptable determination range, but the error will be amplified by an amplifying module. As last, an analog/digital conversion module converts an unadvised analog voltage into a digital voltage, and a logic control module receives the digital voltage, so that touch sensing accuracy gets worse.

Hence, the present invention provides a touch sensing apparatus to decrease the cost and to increase the touch performance.

### SUMMARY OF THE INVENTION

The present invention provides a touch sensing apparatus. In an embodiment, the touch sensing apparatus includes a logic control module, at least one amplifying module, and at least one storage control module. The logic control module generates a plurality of control signals having different control timings, wherein the control signals include an amplifying control signal and a compensating control signal.

Each storage control module includes a plurality of storage capacitors, the storage capacitors at least store a first sensing voltage and a second sensing voltage according to a storage control signal of the control signals, wherein the first sensing voltage and the second sensing voltage are analog data respectively sensed through a first sensing line and a second sensing line of a conductive thin film sensor, and the first sensing line and the second sensing line are the sensing lines of adjacent channels.

It is noted that each amplifying module includes an amplifying unit and an automatic compensating unit. The amplifying unit includes a positive input end and a negative input end, wherein the amplifying unit determines, according to the amplifying control signal, a difference between a first sensing voltage and a second sensing voltage respectively received by the positive input end and the negative input end and amplifies the difference to output an analog data. The automatic compensating unit records, according to the compensating control signal, a digital compensation value corresponding to one of the pins and outputs the digital compensation value according to the compensating control signal.

In practical applications, each amplifying module further includes a digital/analog conversion unit, wherein the digital/analog conversion unit converts the digital compensation value outputted from the automatic compensating unit into an analog compensation value and outputs the analog compensation value to the amplifying unit. In addition, the touch sensing apparatus further includes an analog/digital conversion module, wherein the analog/digital conversion module converts the analog data outputted from the at least one amplifying module into a digital data and transmits the digital data to the logic control module. When the logic control module receives the digital data, the logic control module determines whether the digital data needs to be compensated. If the digital data needs to be compensated, the logic control module outputs the compensating control signal to the automatic compensating unit.

Compared to the prior arts, the touch sensing apparatus of the present invention utilizes the logic control module to generate the compensating control signal, so that the automatic compensating unit compensates the voltages of adjacent channels. In ideal conditions, the voltages of adjacent channels are the same, i.e. the difference of the voltages is 0. In practical applications, the difference of the voltages of adjacent channels is very small. However, because of the yield of the conductive thin film sensor is poor, and the difference of the voltages of adjacent channels largely deviates from that in the ideal condition. Hence, the touch sensing apparatus of the present invention utilizes the automatic compensating unit to compensate the voltage, so that the outputted voltage of the amplifying module is compensated. Moreover, the touch sensing apparatus of the present invention can improve the defect of the poor conductive thin film sensor and utilize the logic control module and the automatic compensating unit to control the quality of the outputted voltages, further decreasing the cost of the touch sensing apparatus.

The detailed descriptions and the drawings thereof below provide further understanding about advantages and the spirit of the present invention.

### BRIEF DESCRIPTION OF THE DRAWINGS

FIG. 1 is a schematic view of a touch sensing apparatus for sensing the touch point on a display panel; and

FIG. 2 is a schematic view of an embodiment of the touch sensing apparatus of the present invention.

### DETAILED DESCRIPTION

One embodiment according to the present invention is a touch sensing apparatus. In the present embodiment, the touch sensing apparatus is a mutual capacitance touch sensing apparatus, but not limited thereto.

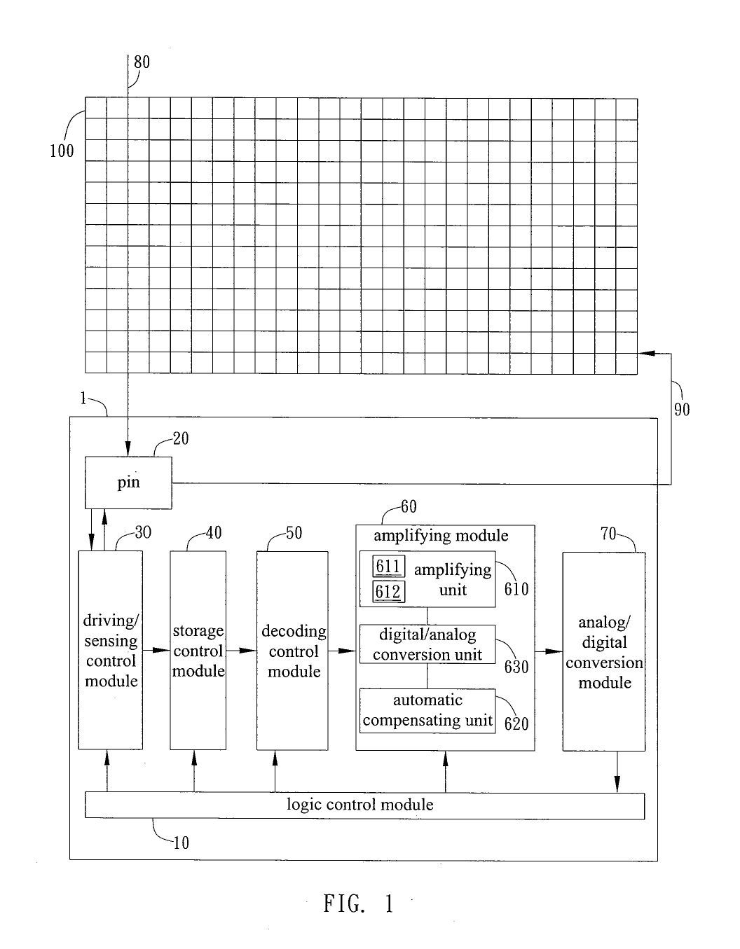

Please refer to FIG. 1. FIG. 1 is a schematic view of a touch sensing apparatus 1 for sensing the touch point on a display panel. As shown in FIG. 1, a liquid crystal display (LCD) panel includes a conductive thin film sensor 100 and the touch sensing apparatus 1. The LCD panel is generally attached to the bottom of the conductive thin film sensor 100, but the location of the LCD panel is not limited to the embodiment. The touch sensing apparatus 1 includes a logic control module 10, a plurality of pins 20, at least one driving/sensing control module 30, at least one storage control module 40, at least one decoding control module 50, at least one amplifying module 60, and an analog/digital conversion module 70. The at least one driving/sensing control module 30 is coupled with the pins 20 and the logic control module 10. The at least one storage control module 40 is coupled with the at least one driving/sensing control module 30 and the logic control module 10. The at least one decoding control module 50 is coupled with the at least one storage control module 40 and the logic control module 10. The at least one amplifying module 60 is coupled with the at least one decoding control module 50 and the logic control module 10. The analog/digital conversion module 70 is coupled with the at least one amplifying module 60 and the logic control module 10.

It is noted that the logic control module 10 generates a plurality of control signals having different control timings, wherein the control signals comprise an amplifying control signal and a compensating control signal.

The pins 20 have more than one function and can switch between different functions based on practical requirements. Examples of the functions include, but are not limited to, driving function, sensing function, ground function, or floating function. Each driving/sensing control module 30 controls the pins 20 to execute the sensing function according to a sensing control signal of the control signals and sense a plurality of analog data via a plurality of sensing lines 80 of the conductive thin film sensor 100.

As shown in FIG. 1, the conductive thin film sensor 100 includes a plurality of sensing lines 80 and a plurality of driving lines 90, wherein the driving lines 90 are arranged perpendicular to the sensing lines 80. It is noticed that the driving lines 90 and the sensing lines 80 can be interchanged with each other; in other words, the driving lines 90 shown in FIG. 1 can serve as the sensing lines, and the sensing lines 80 shown in FIG. 1 can serve as the driving lines, wherein the arrangement of sensing lines and driving lines can be controlled by the touch sensing apparatus 1.

Each driving/sensing control module 30 receives a driving/sensing control signal of the control signals from the logic control module 10 and controls the pins 20 to execute the functions according to the driving/sensing control timing of the driving/sensing control signal, so that the pins 20 respectively sense a first sensing voltage and a second sensing voltage from a first sensing line (not shown) and a second sensing line (not shown) of the conductive thin film sensor 100, wherein the first sensing line and the second sensing line are the sensing lines of adjacent channels, but not limited thereto.

Each storage control module 40 includes a plurality of storage capacitors (not shown), wherein the storage capacitors at least store, according to a storage control signal of the control signals, the first sensing voltage and the second sensing voltage transmitted from the driving/sensing control module 30. Each decoding control module 50 decodes the first sensing voltage and the second sensing voltage outputted from the storage control module 40 according to a decoding control signal of the control signals.

The conductive thin film sensor 100 executes a discharge process after the storage control module 40 stores the analog data in the storage capacitors.

In the present embodiment, the amplifying module 60 includes an amplifying unit 610, an automatic compensating unit 620, and a digital/analog conversion unit 630. The amplifying unit 610 includes a positive input end 611 and a negative input end 612, wherein the amplifying unit 610 determines, according to the amplifying control signal, a difference between the first sensing voltage and the second sensing voltage respectively received by the positive input end 611 and the negative input end 612 and amplifies the difference to output a first analog data to the automatic compensating unit 620 and the analog/digital conversion module 70. The automatic compensating unit 620 is coupled between the logic control module 10 and the amplifying unit 610, wherein the automatic compensating unit 620 records, according to the compensating control signal, a digital compensation value corresponding to one of the pins 20 and outputs the digital compensation value according to the compensating control signal.

The analog/digital conversion module 70 converts the first analog data outputted from the at least one amplifying module 60 into a first digital data and transmits the first digital data to the logic control module 10. When the logic control module 10 receives the first digital data, the logic control module 10 determines whether the first digital data needs to be compensated. If the first digital data needs to be compensated, the logic control module 10 outputs the compensating control signal to the automatic compensating unit 620. The automatic compensating unit 620 generates, according to the compensating control signal, the digital compensation value corresponding to the first digital data and outputs the digital compensation value into the digital/analog conversion unit 630. The digital/analog conversion unit 630 converts the digital compensation value outputted from the automatic compensating unit 620 into an analog compensation value and outputs the analog compensation value to the amplifying unit 610. If the digital data does not need to be compensated, or the first sensing voltage and the second sensing voltage do not need to be compensated, the logic control module 10 does not output any the compensating control signal to the automatic compensating unit 620. In practice, the amplifying module 60 can be an arbitrary type of amplifier; the analog/digital conversion module 70 can be an arbitrary type of analog/digital converter; the digital/analog conversion unit 630 can be an arbitrary type of digital/analog converter. However, the amplifying module 60, the analog/digital conversion module 70, and the digital/analog conversion unit 630 are not limited to the embodiment.

The first sensing voltage and the second sensing voltage receive the analog compensation value outputted from the digital/analog conversion unit 630 for compensating the voltages. After compensating the voltages, the amplifying module 60 outputs a second analog data to the analog/digital conversion module 70. The analog/digital conversion module 70 converts the second analog data to a second digital data and transmits the second digital data into the logic control module 10. When the logic control module 10 receives the second digital data, the logic control module 10 determines whether the second digital data is within the compensation range. Since the second digital data is compensated, the second digital data is within the compensation range.

It is noted that the automatic compensating unit 620 records the digital compensation value corresponding to the pin 20 according to the compensating control signal. Hence, when the same pin 20 transmits the sensing voltage, the automatic compensating unit 620 transmits the digital compensation value corresponding to the pin 20, so that the sensing voltage transmitted from the pin 20 is compensated.

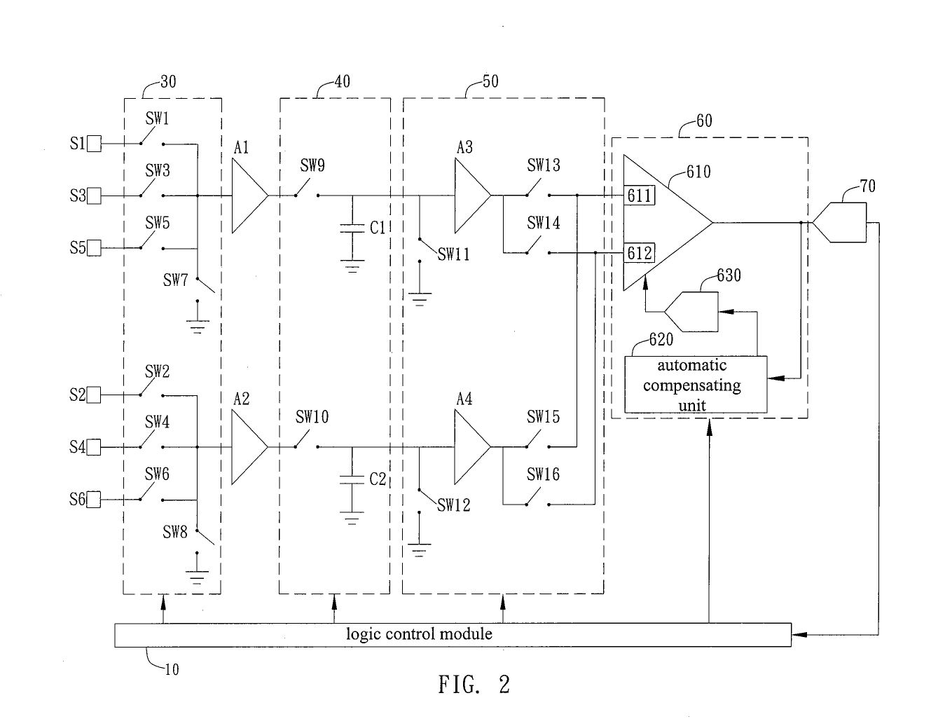

Please refer to FIG. 2. FIG. 2 is a schematic view of an embodiment of the touch sensing apparatus 1 of the present invention. As shown in FIG. 2, the touch sensing apparatus 1 includes a first pin S1 to a sixth pin S6 respectively corresponding to the sensing lines (not shown), wherein the pins are in order of the first pin S1, a second pin S2, a third pin S3, a fourth pin S4, a fifth pin S5, and the sixth pin S6, and the sensing lines corresponding to the first pin S1 and the second pin S2 are in adjacent channels.

In the present embodiment, the driving/sensing control module 30 includes a first sensing switch SW1 to a sixth sensing switch SW6 respectively coupled with the first pin S1 to the sixth pin S6. The buffer A1 is coupled with the first sensing switch SW1 and the storage control module 40; the buffer A2 is coupled with the second sensing switch SW2 and the storage control module 40.

In a preset condition, ground switches SW7, SW8, SW11, and SW12 are all in closed state, and the other switches are in open state.

In practical applications, the logic control module 10 generates the driving/sensing control signal outputted to the driving/sensing control module 30 to control the first sensing switch SW1 and the second sensing switch SW2 and to control the ground switch SW7 and SW8 to be deactivated (i.e. in open state), so that the first sensing pin S1 and the second sensing pin S2 respectively receive the first sensing voltage and the second sensing voltage from the first sensing line (not shown) and the second sensing line (not shown) of the conductive thin film sensor 100, and respectively output the first sensing voltage and the second sensing voltage to the buffers A 1 and A2.

The storage control module 40 includes storage switches SW9/SW10 and storage capacitors C1/C2, wherein the storage switches SW9/SW10 are coupled with the buffers A1/A2 and the storage capacitors C1/C2. The logic control module 10 generates the storage control signal to control the first sensing switch SW1 and the second sensing switch SW2 to be deactivated (i.e. in open state), to control the storage switches SW9/SW10 to be activated (i.e. in closed state), and to control the ground switches SW11/SW12 to be deactivated (i.e. in open state). The storage capacitors C1/C2 store the first sensing voltage and the second sensing voltage transmitted from the driving/sensing control module 30 according to the storage control signal.

The decoding control module 50 includes a ground switch SW11, a ground switch SW12, a buffer A3, a buffer A4, a positive input switch SW13, a negative input switch SW14, a positive input switch SW15, and a negative input switch SW16. The buffer A3 is coupled with the storage control module 40 and the positive input switch SW13; the buffer A4 is coupled with the storage control module 40 and the positive input switch SW15; the negative input switch SW14 is coupled with the buffer A3 and the amplifying module 60; the negative input switch SW16 is coupled with the buffer A4 and the amplifying module 60.

As shown in FIG. 2, the logic control module 10 generates the decoding control signal outputted to the decoding control module 50 to control the storage switches SW9/SW10 to be deactivated (i.e. in open state), so that the first sensing voltage and the second sensing voltage are respectively outputted to the buffers A3/A4.

The amplifying module 60 includes the amplifying unit 610, the automatic compensating unit 620, and the digital/analog conversion unit 630, wherein the amplifying unit 610 includes the positive input end 611 and the negative input end 612. The positive input switch SW13 is coupled with the buffer A3 and the positive input end 611; the negative input switch SW16 is coupled with the buffer A4 and the negative input end 612. The logic control module 10 generates amplifying control signal to the control positive input switch SW13 and the negative input switch SW16 to be activated (i.e. in closed state), so that the first sensing voltage and the second sensing voltage are respectively outputted to the positive input end 611 and the negative input end 612.

The touch sensing apparatus 1 further includes the ground switches SW7, SW8, SW11, and SW12, wherein the ground switch SW7 is coupled with the first sensing switch SW1 and a ground end; the ground switch SW8 is coupled with the second sensing switch SW2 and the ground end; the ground switch SW11 is coupled with the storage capacitor C1 and the ground end; the ground switch SW12 is coupled with the storage capacitor C2 and the ground end. When the first sensing voltage and the second sensing voltage are respectively outputted to and stored in the storage capacitors C1 and C2, the logic control module 10 transmits a ground control signal and the storage control signal respectively to the driving/sensing control module 30 and the storage control module 40, so that the storage switches SW9/SW10 are deactivated and the ground switches SW7/SW8 are activated, avoiding the residual charges of the conductive thin film sensor 100 to influence the sensing accuracy of the pins 20. It is noticed that before the first sensing voltage and the second sensing voltage are respectively outputted to and stored in the storage capacitors C1 and C2, the logic control module 10 transmits the ground control signal to the decoding control module 50 to control the ground switches SW11/SW12 to be activated, further releasing the voltages stored in the storage capacitors C1/C2 to increase the sensing accuracy during the sensing of the touch sensing apparatus 1.

When the storage switches SW9/SW10 are deactivated and the ground switches SW7/SW8 are activated, the logic control module 10 transmits the decoding control signal into the decoding control module 50 to transmit the first sensing voltage and the second sensing voltage stored in the storage capacitors C1 and C2 respectively to the positive input end 611 and the negative input end 612 of the amplifying unit 610.

It is noted that the amplifying unit 610 determines, according to the amplifying control signal, a difference between the first sensing voltage and the second sensing voltage respectively received by the positive input end 611 and the negative input end 612 and amplifies the difference to output an analog data to the automatic compensating unit 620 and the analog/digital conversion module 70. The automatic compensating unit 620 is coupled with the logic control module 10 and the amplifying unit 610, the automatic compensating unit records, according to the compensating control signal, the digital compensation value corresponding to one of the pins 20 and outputs the digital compensation value according to the compensating control signal.

In the present embodiment, the analog/digital conversion module 70 converts the first analog data outputted from the amplifying module 60 into the first digital data and transmits the first digital data to the logic control module 10. When the logic control module 10 receives the first digital data, the logic control module 10 determines whether the first digital data needs to be compensated. If the first digital data needs to be compensated, the logic control module 10 outputs the compensating control signal to the automatic compensating unit 620. The automatic compensating unit 620 generates the digital compensation value corresponding to the first digital data and outputs the digital compensation value to the digital/analog conversion unit 630. The digital/analog conversion unit 630 converts the digital compensation value outputted from the automatic compensating unit 620 into the analog compensation value and outputs the analog compensation value into the amplifying unit 610. The compensation process is completed after repeating the compensating steps, and the voltages are compensated.

After compensating the voltages, the amplifying module 60 outputs the second analog data to the analog/digital conversion module 70. The analog/digital conversion module 70 converts the second analog data into the second digital data and transmits the second digital data to the logic control module 10. When the logic control module 10 receives the second digital data, the logic control module 10 determines whether the second digital data is within the compensation range. Since the second digital data is compensated, the second digital data is within the compensation range.

It is noted that the automatic compensating unit 620 records the digital compensation value corresponding to the pin 20 according to the compensating control signal. Hence, even the same pin 20 transmits the sensing voltage, the automatic compensating unit 620 transmits the digital compensation value corresponding to the pin 20, so that the sensing voltage transmitted from the pin 20 is compensated. In other words, when the first pin S1 and the second pin S2 transmit the sensing voltages to the amplifying unit 610 again, the automatic compensating unit 620 immediately transmits, according to the compensating control signal, the digital compensation value corresponding to the pins 20 without transmitting the sensing voltages to the analog/digital conversion module 70 and the logic control module 10 for judgement of compensating.

Compared to the prior arts, the touch sensing apparatus of the present invention utilizes the logic control module to generate the compensating control signal, so that the automatic compensating unit compensates the voltages of adjacent channels. In ideal conditions, the voltages of adjacent channels are the same, i.e. the difference of the voltages is 0. In practical applications, the difference of the voltages of adjacent channels is very small. However, because of the yield of the conductive thin film sensor is poor, and the difference of the voltages of adjacent channels largely deviates from that in the ideal condition. Hence, the touch sensing apparatus of the present invention utilizes the automatic compensating unit to compensate the voltage, so that the outputted voltage of the amplifying module is compensated. Moreover, the touch sensing apparatus of the present invention can repair defect of the poor conductive thin film sensor and utilizes the logic control module and the automatic compensating unit to control the quality of the outputted voltages, further decreasing the cost of the touch sensing apparatus.

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A touch sensing apparatus, comprising:
a plurality of pins;
a logic control module generating a plurality of control signals having different control timings, wherein the control signals comprise an amplifying control signal and a compensating control signal; and
at least one amplifying module, wherein each amplifying module comprises:
an amplifying unit comprising a positive input end and a negative input end, wherein the amplifying unit determines, according to the amplifying control signal, a difference between a first sensing voltage and a second sensing voltage respectively received by the positive input end and the negative input end and amplifies the difference to output an analog data; and
an automatic compensating unit coupled between the logic control module and the amplifying unit, the automatic compensating unit records, according to the compensating control signal, wherein a digital compensation value corresponding to one of the pins and outputs the digital compensation value according to the compensating control signal.

2. The touch sensing apparatus of claim 1, wherein each amplifying module further comprises:
a digital/analog conversion unit coupled with the automatic compensating unit and the amplifying unit, wherein the digital/analog conversion unit converts the digital compensation value outputted from the automatic compensating unit into an analog compensation value and outputs the analog compensation value to the amplifying unit.

3. The touch sensing apparatus of claim 1, further comprising:
an analog/digital conversion module coupled with the at least one amplifying module and the logic control module, wherein the analog/digital conversion module converts the analog data outputted from the at least one amplifying module into a digital data and transmits the digital data to the logic control module.

4. The touch sensing apparatus of claim 3, wherein when the logic control module receives the digital data, the logic control module determines whether the digital data needs to be compensated; if the digital data needs to be compensated, the logic control module outputs the compensating control signal to the automatic compensating unit.

5. The touch sensing apparatus of claim 1, wherein the pins execute a sensing function, a driving function, a grounding function, and/or a floating function.

6. The touch sensing apparatus of claim 5, further comprising:
at least one driving/sensing control module coupled with the pins and the logic control module, wherein the driving/sensing control module controls the pins to execute the sensing function according to a sensing control signal of the control signals and sense a plurality of analog data via a plurality of sensing lines of a conductive thin film sensor.

7. The touch sensing apparatus of claim 6, further comprising:
at least one storage control module coupled with the driving/sensing control module and the logic control module, wherein each storage control module comprises a plurality of storage capacitors, the storage capacitors at least store the first sensing voltage and the second sensing voltage according to a storage control signal of the control signals, the first sensing voltage and the second sensing voltage are analog data respectively sensed through a first sensing line and a second sensing line of the conductive thin film sensor, and the first sensing line and the second sensing line are the sensing lines of adjacent channels.

8. The touch sensing apparatus of claim 7, further comprising:
at least one decoding control module coupled with the storage control module and the logic control module, wherein the decoding control module decodes the first sensing voltage and the second sensing voltage outputted from the storage control module according to a decoding control signal of the control signals.

9. The touch sensing apparatus of claim 1, wherein the automatic compensating unit generates the digital compensation value corresponding to the one of the pins according to the compensating control signal.

10. The touch sensing apparatus of claim 7, wherein the conductive thin film sensor executes a discharge process after the storage control module stores the analog data in the storage capacitors.
